(19) United States
(12) Patent Application Publication
(10) Pub. No.: US 2002/0013146 A1
(43) Pub. Date: Jan. 31, 2002

(54) Device for switching, controlling and monitoring appliances

(76) Inventor: Thomas Albrecht, Vienna (AT)

Correspondence Address: Thomas R. Vigil, c/o Vigil & Associates, 836 South Northwest Highway, Barrington, IL, 60010, US

(21) Appl. No.: 09/953,800

(22) Filed: Sep. 17, 2001

Related U.S. Application Data
(63) Continuation-in-part of application No. PCT/AT99/00301, filed on Dec. 6, 1999.

(30) Foreign Application Priority Data
Mar. 15, 1999 (AT) A 457/99

(51) Int. Cl. H04M 3/00

(52) U.S. Cl. 455/420; 455/418

(57) ABSTRACT

Apparatus for switching, controlling and monitoring devices, in particular devices used in domestic and functional buildings, consisting of a base station (BAS) with at least one processor and a storage device which comprises one or several interfaces (SC1-SC4) by means of which the devices (GE1-GE3, BG1-BG3) can be electrically connected to the base station (BAS) and furthermore of at least one terminal (TE1, TE2) which is allocated to the base station (BAS). The base station (BAS) is set up in such a way as to transmit control signals to devices (GE1-GE3, BG1-BG3) and to receive information signals from devices (GE1-GE3, BG1-BG3), furthermore the base station (BAS) is set up for the free configuration of scenarios which relate to switching and control processes on any devices (GE1-GE3, BG1-BG3). Scenarios can be activated by activation signals to the base station (BAS), wherein after activation of a scenario the devices concerned (GE1-GE3, BG1-BG3) are switched and/or controlled by means of control signals from the base station (BAS). The terminal (TE1, TE2) is set up in such a way as to transmit activation signals to the base station (BAS) and to receive status signals from the base station (BAS).

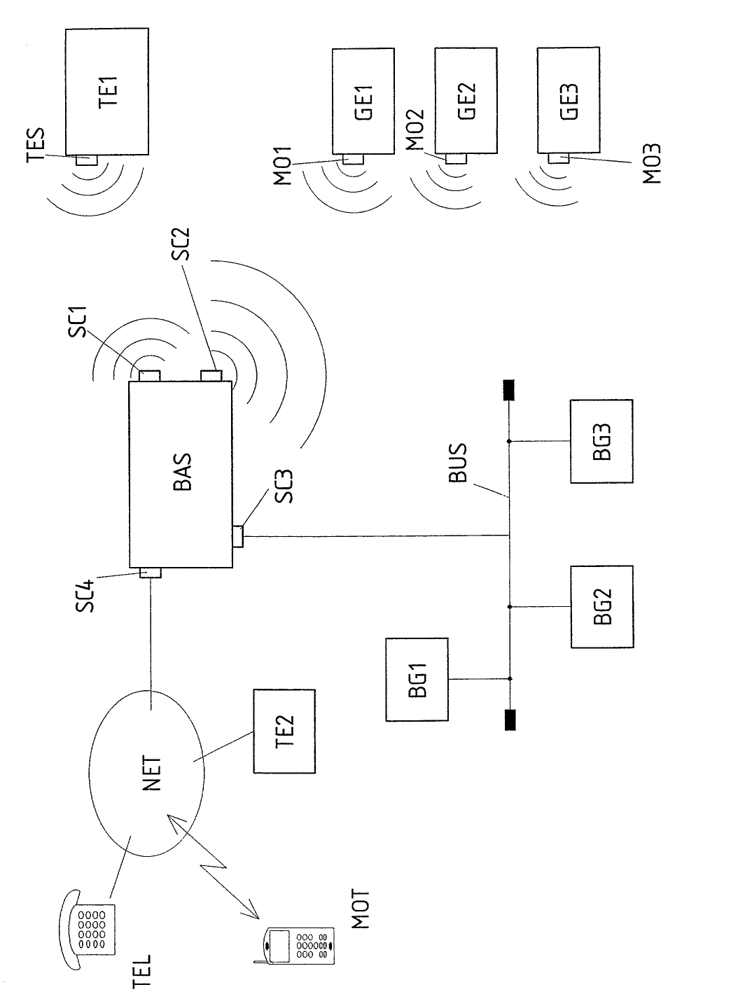

### DESCRIPTION

The invention relates to a device for switching, controlling and monitoring devices, in particular devices for domestic and functional buildings, consisting of a base station with at least one processor and a storage device which has one or more interfaces by means of which the said devices can be electrically connected to the base station.

Continually increasing demands are being placed on the electrical installations in buildings. Although the simple switching on or off of devices was previously sufficient, over the course of time controlling and reporting functions and energy and time management functions have been incorporated into the operational scope of electrical installations.

At this point it should be mentioned that devices, in particular household devices, should be understood to mean in this case not only conventional devices such as dishwashers, cookers, televisions etc., but that the term “devices” also designates hereinunder alarm installations, movement detectors, lighting installations, heating controls etc. Furthermore, the following considerations can also be used for office devices such as copiers, personal computers, fax machines, answer machines, etc., wherein differentiation between office devices and devices which are used in domestic buildings or rooms is not necessary either, in most cases, for clarity or with respect to the invention.

For the various applications, such as, for example, blind, window or heating controls, individual, mutually separate systems for control and monitoring have usually been installed in the past (“discrete solutions”). Since, in that case every device to be controlled or switched requires its own control device, this is associated with high wiring costs and a mass of cables. In addition, changes in the usage of buildings or rooms often requires the rewiring of various devices, which is naturally associated with high labour costs

It is desirable that, for example, when a heating phase is activated the windows in the heated rooms are automatically closed to avoid unnecessary energy losses However, by reason of the independent control systems, as described above, it is often impossible to achieve this since the heating and window controls are generally not set up in such as way as to communicate with each other.

In recent years it has been possible to overcome these difficulties at least in part in that bus systems originating in industry are increasingly penetrating into the area of electrical installations for controlling devices. In contrast to the discrete solutions of the conventional electrical installations the devices can be switched, controlled and monitored by a commonly used cable, the so-called bus. Particular examples are the “Instabus” and the “European Installation Bus” (EIB). The devices connected to the bus are in this case connected to each other by two cables, by means of which they can exchange messages with each other on the one hand and, on the other hand, draw the power supply.

A disadvantage of this use of bus systems is that retrofitting of existing installations is usually time-consuming and labour-intensive or is impossible without a skilled person if expansion possibilities were not considered in the original planning of the system.

It has proved to be particularly disadvantageous that as the number of devices to be controlled increases—wherein the various switching and control processes on different devices are often dependent upon each other—the complexity of operation of the devices is greatly increased. This means that the operation of the various devices is now often only mastered with a great deal of effort, which is a hindrance to the general acceptance and distribution of these systems

In addition, the complexity of the operation of the devices often also causes a “psychological” insecurity factor since monitoring of the switching and control processes becomes more and more difficult as the number of devices increases. This leads to the situation where the user can only see with difficulty if the switching or control processes have been carried out correctly and this frequently leads to a feeling of insecurity.

It is an object of the invention to integrate devices, in particular devices used in households or in functional buildings, into a total system so that on the one hand the operation of these devices is greatly simplified for the user and on the other hand simple monitoring of the devices is possible at a glance.

This object is achieved in accordance with the invention by apparatus of the type mentioned in the introduction in that

the base station is set up in such a way as to transmit control signals to devices and to receive information signals from devices,

the base station is set up for the free configuration of scenarios which relate to switching and control processes on any devices,

scenarios can be activated by activation signals to the base station, wherein after activation of a scenario the devices concerned are switched and/or controlled by means of control signals from the base station,

and, furthermore, at least one terminal is allocated to the base station, wherein the terminal is set in such a way as to transmit activation signals to the base station and to receive status signals from the base station.

The invention thus creates apparatus which makes possible simple operation of devices by the fact that scenarios are freely programmable in the base station, these scenarios can be actuated by means of activation signals to the base station, and the base station actuates the control and switching processes, corresponding to the scenarios, in the devices by means of control signals. By combining frequently occurring control and switching processes, which are often partially or completely dependent upon each other, to form scenarios it is thereby possible to considerably reduce the effort of operating the devices. Furthermore, at least one terminal is allocated to the base station, with the aid of which terminal the base station can be operated easily with respect to the configuration and activation of the scenarios and with respect to the monitoring of the devices.

The terminal is expediently formed as a unit physically separated from the base station and able to be connected to the base station by way of an interface. It is thereby possible to accommodate both the base station and also one or more terminals at the most appropriate locations without having to make compromises in this respect as is necessary if the base station and the terminal are designed as one device.

In one user-friendly embodiment of the invention the terminal has a display, wherein this is advantageously a touch-sensitive display. This serves, on the one hand, to display the status of the various devices, and on the other hand, the touch-sensitive display can be used to input commands and data for activation or configuration of scenarios.

It has, furthermore, proved to be particularly useful for the terminal to be voice-activated. The operation of the base station thereby becomes possible by voice input, at least with respect to fundamental functions.

In one expedient embodiment of the invention provision is made so that it is possible to actuate activation signals for scenarios by means of the terminal. In so doing a command input at the terminal is transmitted to the base station in the form of activation signals, which base station then switches and/or controls the respective devices according to the selected scenario

Furthermore, it can be advantageous if activation signals for scenarios can be actuated in dependence upon physical variables. In this way, for example, if the temperature in a room falls below a certain preset temperature a scenario is activated which closes the windows and activates the heating

In order to be able to monitor the devices it is possible to transmit information signals from switched or controlled devices to the base station according to the respective switching or control processes.

In so doing it is expedient if, furthermore, transmission of status signals from the base station to the terminal is provided according to the activation of scenarios. The activation of a scenario, regardless of whether it was actuated automatically or by a terminal by input of an activation command, results in the base station switching or controlling the corresponding devices with control signals. After these switching and control processes, feedback then takes place from the respective devices to the control device, relating to the success of these control and switching processes. This information is finally passed on to the terminal where it is made accessible to the user by way of the display or voice output.

In one expedient embodiment the devices are switched, controlled and monitored by means of actuators and sensors. The actuators principally serve to convert the control signals from the base station into corresponding switching or control processes on the associated devices, the sensors serve essentially to monitor the status of the respective devices.

Furthermore, it is possible to make provision for the base station to be connectable to a telecommunications network by means of an interface and for the activation signals for scenarios to be initiated by means of a telecommunications network. By means of this connection to a telecommunications network it is made possible to activate individual devices or scenarios or to inquire into the status of the devices remotely by way of the telecommunications network.

In particular, in buildings which have no connection to a fixed network it may be useful if the telecommunications network is a mobile radio communications network in order to be able to access devices remotely even in this case.

In so doing it has proved to be useful if the base station can be connected to a terminal via a telecommunications network. In this way a simple configuration and activation of scenarios and the monitoring of devices can be ensured in a convenient manner even from a distance.

In so doing it has provided to be particularly useful if a terminal can be emulated, at least with respect to fundamental functions, by a mobile radio communications device. Activation of scenarios and the monitoring of the status of the devices in a building is thereby almost independent of one's location at a particular moment. Furthermore, the use of a mobile radio communications device brings about further gains in terms of convenience by reason of its compactness, moreover it is possible to have information about particular events in a building to be monitored, for example by means of SMS (“Short Message Service”).

It is advantageous if the base station can be connected by way of one of the interfaces to a device-specific bus. An already existing bus installation, by means of which different devices are controlled, does not then have to be removed, which would be disadvantageous to the new apparatus in accordance with the invention, but can be incorporated into the new system in a problem-free manner.

Finally, it is of particular advantage if one or more interfaces are designed as radio interfaces. A later addition of devices to an already existing system is then easily possible since no new cables have to be provided. It will then be sufficient to fit newly added devices with an appropriate radio module by means of which the devices are connected to the radio interface(s) of the base station, and to reconfigure the various scenarios.

The invention is described in more detail hereinunder with the aid of the drawing in which the single FIGURE schematically shows apparatus in accordance with the invention for switching, controlling and monitoring devices.

As shown by the FIGURE the apparatus has a base station BAS, wherein the base station BAS has at least one processor and a storage device. In the sketched embodiment this base station BAS has a plurality of interfaces SC1-SC4, wherein some of these interfaces are designed as radio interfaces SC1, SC2. By means of one of these interfaces SC2, which for this purpose is generally formed as a multiplex interface, the base station BAS is connected to various devices GE1-GE3. In the drawing only three devices are shown, in an embodiment which is close to actual practice there will, however, in the most cases be a substantially larger number of connected devices. Thus, for example, kitchen devices such as an electric cooker, dishwasher, microwave, refrigerator etc are connected to the base station BAS, furthermore it is also possible for still more devices such as the television, stereo system etc. to be connected. In addition to these devices in the conventional sense it is also possible for lighting installations, alarm systems, heating, movement detectors, blind and window controls etc. to be connected to the base station.

The devices GE1-GE3 belonging to the apparatus generally include a module MO1-MO3, consisting in each case of a radio interface, an actuator and a sensor, in order to connected to the base station BAS. By means of the radio interface SC2 and the interface of the module MO1-MO3 communication takes place between the respective device GE1-GE3 and the base station BAS, the actuators serve to convert control signals from the base station BAS into control or switching processes in the respective device GE1-GE3. Finally, the sensors are provided to inform the base station BAS about the respective status of the associated device GE1-GE3, for example about the temperature of a cooker hob.

By means of the modules MO1-MO3 it is possible to extend the apparatus in a convenient manner since devices which are to be connected to the base station BAS simply have to be expanded by these modules. Standardisation of these modules is planned for the near future. It is possible to dispense with cabling of the new devices to the base station BAS.

By means of a further interface SC1 the base station BAS is connected to a terminal TE1, wherein the terminal TE1 also has a radio interface TES. It is stated here in advance that in principle the interfaces SC1 and SC2 can also be designed as wired interfaces, with respect to the modularity and expandability of the whole system, however, the use of radio interfaces is preferred. Furthermore, it is also possible to allow both one or a plurality of terminals and also different devices to be connected to the base station by a single multiplex radio interface

The terminal TE1 has at least one display. Furthermore, for the purpose of inputting commands, data etc a keyboard and/or a touch-sensitive display are provided. Moreover, provision is also made that the terminal TE1 has loudspeakers, a microphone and the necessary electronic devices which are known to the person skilled in the art so that voice input and output of commands and/or information via terminal TE1 is possible.

The base station BAS is set up for free configuration of scenarios relating to switching and control processes in the devices GE1-GE3. The inputs of data and commands required for configuration are expediently carried out via the terminal TE1. The configuration of scenarios by the user is assisted by suitable software which gives out at least one warning during configuration of questionable scenarios. Furthermore, it is also possible for scenarios to be defined in the factory or configuration of desired scenarios can be carried out via a telecommunications network—see in this respect the description below.

Scenarios which have been configured can be actuated by input of an appropriate command. Generally the respective command is activated by the terminal TE1, for example, by voice input. The terminal TE1 transmits the corresponding activation signal to the base station BAS and the devices GE1-GE3 associated with the respective scenario are operated from the base station BAS by way of the radio interface SC2. The actuators of the devices GE1-GE3 convert the control signals of the base station BAS into corresponding switching and control processes of the devices DE1-DE3.

It is also possible to make provision for scenarios to be automatically actuated, for example, in dependence upon physical variables. It is then feasible that when the temperature falls below a preset defined room temperature a scenario is activated in which the windows are closed and the heating is switched on. However, it is also possible for scenarios to be actuated automatically by certain events. For example, it could then be possible to determine, by means of movement detectors and other sensors, that no one was left in an apartment. This is signalled to the base station BAS by the sensors, wherein a scenario is actuated which is configured in such a way that all the lights are switched off, incoming calls are passed to an answer machine and the room temperature is lowered etc

The deactivation of scenarios is also possible by the input of a command or automatically, it is also possible for a scenario to be cancelled by a subsequent scenario. Of course, a scenario can simply be terminated by all devices returning to their initial status which prevailed before activation of the scenario

In each case information signals from the control or switched devices GE1-GE3 are transmitted to the base station BAS with respect to the switching and control processes. In this way, using the terminal TE1, the user can be informed about the scenarios taking place or about the status of the individual devices GE1-GE3. It has proved to be expedient that for the case where a switching or control process could not be carried out, the user is informed separately, for example by a voice output of the terminal TE1 If desired, it is possible, of course, for a positive actuation of individual scenarios to be additionally confirmed by means of voice output.

As shown by the FIGURE, the base station BAS can also be connected via an interface SC3 to other apparatus for controlling devices. In this case the base station BAS is connected to a device-specific bus BUS, for example an EI-Bus (“European installation bus”) which controls different devices BG1-BG3. By means of this connection capability it is readily possible to incorporate already existing systems for device control, and the devices BG1-BG3 can be included in the scenario formation without particular expense. According to the illustration in the FIGURE the connection of the device-specific bus BUS to the base station BAS is achieved by means of a wire interface, a connection of this type can, however, expediently also be produced by radio interfaces.

Finally, the base station BAS can be connected by an interface SC4 to a telecommunications network NET. In general this is a fixed network, the connection being achieved by means of a modem which is expediently integrated into the base station BAS. The operation of the devices and the monitoring thereof can then take place remotely by voice input and output via a conventional fixed network telephone TEL However, it is more user-friendly when the base station BAS is connected via the telecommunications network NET to a terminal TE2 For this purpose it has proved to be expedient if a portable terminal TE2 is provided. However, the base station BAS can also be connected by means of a telecommunications network to so-called service providers. A service provider of this type can, for example, be a power supply company which informs the base station BAS about a favourable power tariff. By means of this information a corresponding scenario in which, for example, particularly high-energy-consumption devices such as dishwashers or washing machine are switched on, is activated.

In addition, the base station BAS can be connected via a telecommunications network to a security service or to the police. The alerting of these services can then be set in train by the base station BAS via the telecommunications network in the case of unforseen events which are detected, for example, by movement detectors.

Of particular advantage is the possibility of connecting the base station BAS, via a telecommunications network, to a mobile radio communications device MOT, for example, a GSM mobile telephone (“Global System for Mobile-Communication”). By virtue of this connection capability, it is possible to control and monitor devices connected to the base station BAS by voice input and output from almost any location without it also being necessary to carry a terminal. With modern mobile telephones which support, for example, the WAP-Standard (“Wireless Application Protocol”), a terminal can generally be emulated with respect to all its functions. In this way ease of use can be greatly increased with respect to the use of a fixed network telephone. Furthermore, in the case of unexpected events or scenarios, which take place during the absence of the occupant of the apartment or house, a call can be made to the mobile radio communications device MOT. This can take place, for example, in the form of an SMS call (“Short Message Service”), an e-mail or by spoken communication.

The connection of a mobile radio communications device to the base station BAS can be achieved by a fixed network but also by means of a mobile radio communications network. For this purpose the base station BAS can be fitted for example, with a GSM module. The capability of connection to a mobile radio communications network is of particular significance if the devices to be controlled and monitored are located in a building without a fixed network connection.

Furthermore, it is also feasible to incorporate the base station BAS into a DECT environment (“Digital European standard for Cordless Telephones”), whereby operation of devices by mobile radio communications devices based on the DECT standard becomes possible.

As explained in the paragraphs above, the apparatus in accordance with the invention for switching, controlling and monitoring devices has a large number of advantages. Therefore by means of the possibility of scenario configuration the operation of devices is greatly eased. Frequently used, regularly occurring switching and control process which are often dependent upon each other can thus be activated by a single command. By means of the automatic activation of scenarios by physical variables or by the occurrence of certain pre-defined events it is also possible to reduce the effort required for the operation. It is often the case that when leaving the home one is no longer certain after a little time whether the cooker or iron has been turned off. By automatic activation of an appropriate scenario which switches off all electrical devices upon leaving home the personal feeling of security in this respect can be greatly increased.

A further example for increasing the feeling of security is a scenario for simulating occupancy, which is activated, for example during holidays. In this scenario different devices such as lighting, television, Hi-Fi etc. can be controlled by the base station in such a way that the presence of people is simulated. A scenario of this type can prove to be useful in deterring burglars.

Furthermore, it is possible to contact a holiday home by a telecommunications network. In this case it is possible to envisage a “welcome” scenario which opens the windows of the holiday home to allow fresh air in a certain time before the planned arrival and then, after closing the windows, switches on the heating so that the room temperature is already at a pleasant level upon arrival.

A more detailed description of scenarios will not be entered into at this point since the possibilities are diverse and greatly dependent upon the user.

Information relating to the status of the individual devices can be continually read from the terminal or a mobile radio communications device emulating the terminal. Warnings about switching or control processes which have not been carried out can be emitted in different ways. In this way it is rendered possible to monitor easily the individual devices.

The device is also distinguished by its modular construction which greatly facilitates the purchase of new devices and their inclusion into the scenario formation. If required, terminals can be installed in a number of rooms, furthermore, it is also possible by reason of the radio interfaces, to use portable terminals.

An already existing installation of apparatus for operating devices, such as a device-specific bus, does not have to be discarded if it is desired to use the apparatus in accordance with the invention, since it is possible to connect the bus to the base station. The bus with the associated bus devices can then be controlled via the base station.

Through its modular construction this apparatus in accordance with the invention creates—by combination—a total system for switching, controlling and monitoring devices, which integrates the discrete solutions of the conventional electrical installation. By means of this device it is possible, through the substantially free configuration of scenarios, for the complexity of operation of devices to be greatly reduced, wherein usage of this system for almost all households, offices, etc. and for almost all groups of people is feasible.

1. Apparatus for switching, controlling and monitoring devices, in particular devices used in domestic and functional buildings, consisting of a base station (BAS) with at least one processor and a storage device which comprises one or several interfaces (SC1-SC4) by means of which the said devices (GE1-GE3, BG1-BG3) can be electrically connected to the base station (BAS), characterised in that:
the base station (BAS) is set up in such a way as to transmit control signals to devices (GE1-GE3, BG1-BG3) and to receive information signals from devices (GE1-GE3, BG1-BG3),
the base station (BAS) is set up for the free configuration of scenarios which relate to switching and control processes on any devices (GE1-GE3, BG1-BG3),
scenarios can be activated by activation signals to the base station (BAS), wherein after activation of a scenario the devices concerned (GE1-GE3, BG1-BG3) are switched and/or controlled by means of control signals from the base station (BAS),
and, furthermore, at least one terminal (TE1, TE2) is allocated to the base station (BAS), wherein the terminal (TE1, TE2) is set up in such a way as to transmit activation signals to the base station (BAS) and to receive status signals from the base station (BAS).

2. Apparatus according to claim 1, characterised in that the terminal (TE1) is formed as a unit physically separated from the base station (BAS) and able to be connected to the base station (BAS) by way of an interface (SC1) claim 1 or 2, characterised in that the terminal (TE1, TE2) any one of claims 1 to 3, characterised in that the terminal sensitive display any one of claims 1 to 4, characterised in that the terminal tivated. any one of claims 1 to 5, characterised in that it is possible gnals for scenarios by means of the terminal (TE1, TE2) o any one of claims 1 to 6, characterised in that activation an be automatically actuated in dependence upon physical to any one of claims 1 to 7, characterised in that information d from switched or controlled devices (GE1-GE3, BG1-BG3) AS) according to the respective switching or controlling to any one of claims 1 to 8, characterised in that status signals the base station (BAS) to the terminal (TE1, TE2) according to narios g to any one of claims 1 to 9, characterised in that the devices BG3) are switched, controlled and monitored by means of rs. g to any one of claims 1 to 10, characterised in that the base station (BAS) can be connected to a telecommunications network (NET) by way of an interface (SC4) and activation signals for scenarios can be actuated via a telecommunications network (NET)

12. Apparatus according to claim 11, characterised in that the telecommunications network (NET) is a mobile radio network

13. Apparatus according to claim 11 or 12, characterised in that the base station (BAS) can be connected via a telecommunications network (NET) to a terminal (TE2).

14. Apparatus according to any one of claims 11 to 13, characterised in that a terminal can be emulated at least with respect to fundamental functions by a mobile radio communications device (MOT).

15. Apparatus according to any one of claims 1 to 14, characterised in that the base station (BAS) can be connected via an interface (SC3) to a device-specific bus (BUS).

16. Apparatus according to any one of claims 1 to 15, characterised in that one or several interfaces (SC1-SC4) are designed as radio interfaces.
